(19) United States
(12) Patent Application Publication
(10) Pub. No.: US 2021/0070921 A1
(43) Pub. Date: Mar. 11, 2021

(54) Water-washable UV-curable resin and preparation method thereof

(71) Applicant: SHENZHEN ZHINENGPAI TECHNOLOGY CO., LTD, Shenzhen City (CN)

(72) Inventor: YINGSHENG HONG, Shenzhen City (CN)

(21) Appl. No.: 16/872,398

(22) Filed: May 12, 2020

(30) Foreign Application Priority Data
Sep. 5, 2019 (CN) 201910835200.1

(51) Int. Cl. C08G 18/48; B08B 7/02; C08G 18/24; C08G 18/75; C08K 3/22; C08G 18/28; C08G 18/34

(52) U.S. Cl. CPC C08G 18/4845; B08B 7/028; C08G 18/242; C08G 18/755; B82Y 30/00; C08G 18/2815; C08G 18/348; C08G 18/4829; C08K 2003/2224; C08K 3/22

(57) ABSTRACT

The present invention discloses a water-washable UV-curable resin and preparation method thereof, solving the problems of the existing water-washable, photo-curable resin when removing the excess resin. The present invention includes the following raw materials in parts by weight: 1-10 parts of Poly[oxy(methyl-1,2-ethanediyl)] ether glycol, 1-10 parts of Poly(propylene glycol), 5-10 parts of Isophorone diisocyanate, 0.5-2 parts of Dibutyltin dilaurate, 2-5 parts of 2,2-Bis(hydroxymethyl) propionic acid, 2-5 parts of Hydroxyethyl Acrylate, 0.1-0.2 parts of 4-Methoxyphenol, 2-5 parts of 2,2-dimethyl trimethylene cyclic carbonate, 2-7 parts of Nano magnesium hydroxide, 1-10 parts of photoinitiator, 10-30 parts of Glycerol 1,3-dimethacrylate, and 10-30 parts of Hexanediol diacrylate. The final product of present invention is of excellent hydrophilicity and mechanical properties, furthermore, it is short in curing time, good in solvent resistance, environmental friendly and easy to clean.

### TECHNICAL FIELD

The present invention relates to the field of 3D printing, more specifically, it is a water-washable UV-curable resin.

### BACKGROUND

With the popularization of 3D printing technology, DLP/SLA 3D printing technology is increasingly applied in daily life. And 3D printing also known as “rapid prototyping”, manufactures three-dimensional objects by stacking printed materials layer by layer.

It is necessary to conduct an UV-curing process after 3D printing, which is therefore accompanied by the need to remove the excess resin. At present, most of the excess resin is removed with solvent by soaking it in isopropanol and acetone. However, these chemicals have safety issues and irritating odors, posing a threat to the human body and the environment. Therefore people are also conducting researches on related aspects.

### SUMMARY OF THE INVENTION

The purpose of the embodiments in present invention is to provide a water-washable UV-curable resin so that the above problems mentioned in the background could be addressed. To achieve the above object, the embodiments in present invention proposes the following technical solutions:

A water-washable UV-curable resin includes the following raw materials in parts by weight: 1-10 parts of Poly[oxy(methyl-1,2-ethanediyl)] ether glycol, 1-10 parts of Poly(propylene glycol), 5-10 parts of Isophorone diisocyanate, 0.5-2 parts of Dibutyltin dilaurate, 2-5 parts of 2,2-Bis(hydroxymethyl)propionic acid, 2-5 parts of Hydroxyethyl Acrylate, 0.1-0.2 parts of 4-Methoxyphenol, 2-5 parts of 2,2-dimethyl trimethylene cyclic carbonate, 2-7 parts of Nano magnesium hydroxide, 1-10 parts of photoinitiator, 10-30 parts of Glycerol 1,3-dimethacrylate, and 10-30 parts of Hexanediol diacrylate.

As a further solution of the embodiment in present invention, the Poly[oxy(methyl-1,2-ethanediyl)] ether glycol applied is a commercially available product.

As a further solution of the embodiment in present invention, the particle size of the Nano magnesium hydroxide is around 18 to 65 nm.

The method for preparing a water-washable UV-curable resin including the following specific steps of :
Step 1: weighing the raw materials according to the ratio;
Step 2: mixing the raw materials to obtain a mixture, then putting the mixture in water and washing it for 5 to 15 minutes with ultrasonic waves, and then stirring it evenly to get the final product.

As a further solution of the embodiment in present invention, the water temperature of the ultrasonic washing in Step 2 should be 36° C. to 46° C., and the ultrasonic washing process is performed in an ultrasonic cleaning machine.

As a further solution of the embodiment in present invention, the power of the ultrasonic cleaning machine is 220 W to 380 W, and the frequency of the ultrasonic waves within the ultrasonic cleaning machine is around 28 KHz to 40 KHz.

As a further solution of the embodiment in present invention, the rotation speed of the stirring in Step 2 is 240 rpm to 450 rpm.

Compared with the prior art, the beneficial effects of the embodiments in present invention are as follows:

The raw material used in present invention has a wide range of sources and the final product is of excellent hydrophilicity and mechanical properties, furthermore, it is short in curing time, good in solvent resistance, environmental friendly and easy to clean. The final product in present invention after being 3D printed would comprise uncured excess materials, and those uncured excess materials could be dissolved and removed by washing and soaking in water within a short time. So the final product in present invention has a broad application prospect.

### DETAILED DESCRIPTION

The technical solutions in present invention will be further described in detail below with reference to specific embodiments.

### Embodiment 1

The water-washable UV-curable resin includes raw materials of following weights: 1 kg of Poly[oxy(methyl-1,2-ethanediyl)] ether glycol, 1 kg of Poly(propylene glycol), 5 kg of Isophorone diisocyanate, 0.5 kg of Dibutyltin dilaurate, 2 kg of 2,2-Bis(hydroxymethyl)propionic acid, 2 kg of Hydroxyethyl Acrylate, 0.01 kg of 4-Methoxyphenol, 2 kg of 2,2-dimethyl trimethylene cyclic carbonate, 2 kg of Nano magnesium hydroxide, 1 kg of photoinitiator, 10 kg of Glycerol 1,3-dimethacrylate, and 10 kg of Hexanediol diacrylate.

The method for preparing a water-washable UV-curable resin includes the following specific steps of:

Step 1: weighing the raw materials according to the ratio;

Step 2: mixing the raw materials to get a mixture, then putting the mixture into 36° C. water and ultrasonically washing it with an ultrasonic cleaning machine for 5 minutes, wherein the power of the ultrasonic cleaning machine is 240 W and the frequency of the ultrasonic waves within the ultrasonic cleaning machine is 33 KHz, and then stirring it evenly to get the final product.

### Embodiment 2

The water-washable UV-curable resin includes the raw materials of the following weights: 3.6 kg of Poly[oxy(methyl-1,2-ethanediyl)] ether glycol, 2.75 kg of Poly(propylene glycol), 6.1 kg of Isophorone diisocyanate, 0.78 kg of Dibutyltin dilaurate, 2.6 kg of 2,2-Bis(hydroxymethyl)propionic acid, 2.66 kg of Hydroxyethyl Acrylate, 0.07 kg of 4-Methoxyphenol, 2.84 kg of 2,2-dimethyl trimethylene cyclic carbonate, 4.48 kg of nano magnesium hydroxide, 5.08 kg of cationic photoinitiator, 17.9 kg of Glycerol 1,3-dimethacrylate, and 19.4 kg of Hexanediol diacrylate.

The method for preparing a water-washable UV-curable resin includes the following specific steps of:

Step 1: weighing the raw materials according to the ratio;

Step 2: mixing the raw materials to get a mixture, and putting the mixture into water and ultrasonically washing for 10 minutes, and then stirring it evenly at 330 rpm to get the final product.

### Embodiment 3

The water-washable UV-curable resin includes the raw materials of the following weights: 7.45 kg of Poly[oxy(methyl-1,2-ethanediyl)] ether glycol, 6.8 kg of Poly(propylene glycol), 8.75 kg of Isophorone diisocyanate, 1.46 kg of Dibutyltin dilaurate, 4.26 kg of 2,2-Bis(hydroxymethyl)propionic acid, 3.94 kg of Hydroxyethyl Acrylate, 0.14 kg of 4-Methoxyphenol, 4.45 kg of 2,2-dimethyl trimethylene cyclic carbonate, 6.33 kg of Nano magnesium hydroxide, 8.69 kg of photo initiator, 23.67 kg of Glycerol 1,3-dimethacrylate, and 26.89 kg of Hexanediol diacrylate.

The method for preparing a water-washable UV-curable resin includes the following specific steps of:

Step 1: weighing the raw materials according to the ratio;

Step 2: mixing the raw materials to obtain a mixture, then putting the mixture into 42° C. water and ultrasonically washing with an ultrasonic cleaning machine for 10 minutes, wherein the power of the ultrasonic cleaning machine is 270 W, and the frequency of the ultrasonic waves within the ultrasonic cleaning machine is 36 KHz, and then stirring it evenly at 420 rpm to get the final product.

### Embodiment 4

The water-washable UV-curable resin includes the raw materials of the following weights: 10 kg of Poly[oxy(methyl-1,2-ethanediyl)] ether glycol, 10 kg of Poly(propylene glycol), 10 kg of Isophorone diisocyanate, 2 kg of Dibutyltin dilaurate, 5 kg of 2,2-Bis(hydroxymethyl)propionic acid, 5 kg of Hydroxyethyl Acrylate, 0.2 kg of 4-Methoxyphenol, 5 kg of 2,2-dimethyl trimethylene cyclic carbonate, 7 kg of Nano magnesium hydroxide, 10 kg of photoinitiator, 30 kg of Glycerol 1,3-dimethacrylate, and 30 kg of Hexanediol diacrylate.

The method for preparing a water-washable UV-curable resin includes the following specific steps of:

Step 1: weighing the raw materials according to the ratio;

Step 2: mixing the raw materials to obtain a mixture, then putting the mixture into 40° C. water and ultrasonically washing with an ultrasonic cleaner for 15 minutes, and then stirring it evenly at 450 rpm to get the final product.

### Comparative Embodiment 1

The light curable resin of Sanmu Group was used as the comparative embodiment 1.

### Comparative Embodiment 2

The light curable resin of Bayer Company was used as the comparative embodiment 2.

The products in embodiment 1, embodiment 4, comparative embodiment 1 and comparative embodiment 2 were all tested for performance. The test results are shown in Table 1.

TABLE 1

| | Embodi- | Embodi- | Comparative | Comparative |
|---|---|---|---|---|
| Item | ment 1 | ment 4 | Embodiment1 | Embodiment2 |
| Percentage of | 2.6 | 2.9 | 3.2 | 2.9 |
| breaking | | | | |
| elongation (%) | | | | |
| Light curable | Excellent | Excellent | Excellent | Excellent |
| activity | | | | |
| shrinkage of | 2.5 | 2.4 | 2.5 | 2.6 |
| cured resin (%) | | | | |
| Viscosity | 3.2 | 3.6 | 3.8 | 3.5 |
| (cps/25 □) | | | | |
| Impact Strength | 29.8 | 28.6 | 28.5 | 29.0 |
| of Notch | | | | |
| (KJ/m²) | | | | |
| Tensile Strength | 24.78 | 25.65 | 25.5 | 24.8 |
| (MPa) | | | | |
| GB/T20197-2006 | Standards | Standards | Standards | Standards |
| | compliant | compliant | compliant | compliant |
| Washing | 9 | 9 | 1 | 1 |
| cleanliness | | | | |

In the column of washing cleanliness, 10 represents the best and 1 represents the worst.

It can be seen from Table 1 that the products of embodiment 1 and embodiment 4 are similar to the products of comparative embodiment 1 and comparative embodiment 2 in mechanical properties and light curable activity. However, the washing cleanliness of the products of embodiment 1 and embodiment 4 is far superior to the products of comparative embodiment 1 and comparative embodiment 2, indicating that the products in present invention are good in washing effect.

The above embodiments are only the better implementation of the present invention and are not intended to limit the present invention. Any modification, equivalent replacement, improvement, etc. made within the spirit and principle of the present invention should be included within the scope of present invention.

In addition, it should be understood that although the present invention is described according to the embodiments, not each embodiment merely contains an independent technical solution. The description is only for the sake of clarity, and those skilled in the art should take this description as a whole. And the technical solutions in the embodiments can also be combined appropriately to form other embodiments that can be understood by those skilled in the art.

1. A water-washable UV-curable resin including the following raw materials in parts by weight: 1-10 parts of Poly[oxy(methyl-1,2-ethanediyl)] ether glycol, 1-10 parts of Poly(propylene glycol), 5-10 parts of Isophorone diisocyanate, 0.5-2 parts of Dibutyltin dilaurate, 2-5 parts of 2,2-Bis(hydroxymethyl)propionic acid, 2-5 parts of Hydroxyethyl Acrylate, 0.1-0.2 parts of 4-Methoxyphenol, 2-5 parts of 2,2-dimethyl trimethylene cyclic carbonate, 2-7 parts of Nano magnesium hydroxide, 1-10 parts of photoinitiator, 10-30 parts of Glycerol 1,3-dimethacrylate, and 10-30 parts of Hexanediol diacrylate.

2. The water-washable UV-curable resin according to claim 1, wherein the Poly[oxy(methyl-1,2-ethanediyl)] ether glycol applied, is a commercially available product.

3. The water-washable UV-curable resin according to claim 1, wherein the particle size of the Nano magnesium hydroxide, is 18 to 65 nm.

4. A method for preparing the water-washable UV-curable resin according to any of claims 1, including the following specific steps of:
Step 1: weighing the raw materials according to the ratio;
Step 2: mixing the raw materials to obtain a mixture, then putting the mixture into water and washing it for 5 to 15 minutes with ultrasonic waves, and stirring it evenly to obtain the final product.

5. The method for preparing a water-washable UV-curable resin according to claim 4, wherein the water temperature for the ultrasonic washing in Step 2 should be between 36° C. to 46° C., and the ultrasonic washing process is performed in an ultrasonic cleaning machine.

6. The method for preparing a water-washable UV-curable resin according to claim 5, wherein the power of the ultrasonic cleaning machine is 220 W to 380 W, and the frequency of the ultrasonic waves within the ultrasonic cleaning machine is 28 KHz to 40 KHz.

7. The method for preparing a water-washable UV-curable resin according to claim 4, wherein the rotation speed of the stirring in Step 2 is 240 rpm to 450 rpm.

8. The water-washable UV-curable resin according to claim 2, wherein the particle size of the Nano magnesium hydroxide is around 18 to 65 nm.

9. A method for preparing the water-washable UV-curable resin according to any of claim 2, including following specific steps of:
Step 1: weighing the raw materials according to the ratio;
Step 2: mixing the raw materials to obtain a mixture, then putting the mixture into water and washing it for 5 to 15 minutes with ultrasonic waves, and stirring it evenly to obtain the final product.

10. A method for preparing the water-washable UV-curable resin according to any of claim 3, including following specific steps of:
Step 1: weighing the raw materials according to the ratio;
Step 2: mixing the raw materials to obtain a mixture, then putting the mixture into water and washing it for 5 to 15 minutes with ultrasonic waves, and stirring it evenly to obtain the final product.
